(19) United States
(12) Patent Application Publication
(10) Pub. No.: US 2004/0178862 A1
(43) Pub. Date: Sep. 16, 2004

(54) Systems and methods for providing independent transmit paths within a single phased-array antenna

(76) Inventors: Mitch Kaplan, Lake Forest Park, WA (US); Scot D. Gordon, Bothell, WA (US)

Correspondence Address: FULBRIGHT & JAWORSKI L.L.P., Jerry L. Mahurin, Suite 2800, 2200 Ross Avenue, Dallas, TX, 75201-2784, US

(21) Appl. No.: 10/385,770

(22) Filed: Mar. 11, 2003

(51) Int. Cl. H01P 5/18

(52) U.S. Cl. 333/117

(57) ABSTRACT

A system for providing independent or co-spatial antenna patterns for independent inputs from a basestation comprises a phased-array antenna having a plurality of antenna columns radiating generally redundant antenna beam patterns. The array employs a feed network for feeding the antenna elements of the array. The feed network receives a plurality of independent inputs. Each of the inputs is split to feed specific ones of the antenna elements and to be combined and correspondingly weighted for output to a shared plurality of the antenna elements of the array. In one embodiment this combining and weighting is carried out by at least one hybrid matrix combiner. The weighting may include adjusting amplitudes and phases of the outputs by the combiner.

### CROSS-REFERENCE TO RELATED APPLICATION

The present application is related to commonly owned Published U.S. Patent Application number 2002/0193104 (Ser. No. 09/878,599) entitled SHAPABLE ANTENNA BEAMS FOR CELLULAR NETWORKS, filed Jun. 11, 2001, published Dec. 19, 2002, the disclosure of which is hereby incorporated herein in its entirety.

### TECHNICAL FIELD

The present invention broadly relates to wireless communications and specifically to providing independent transmit paths within a single phased-array antenna using hybrid micro-strip or strip-line structures.

### BACKGROUND OF THE INVENTION

Problematically, the prior art does not facilitate accessing a single antenna aperture within an antenna array by multiple radios. Therefore, an operator of, for example, a Global System for Mobile communications (GSM) or Code Division Multiple Access (CDMA) basestation, has not typically been able to use multiple radios with a same antenna element in a practical manner.

The use of multiple radios in cellular or other RF communication basestations is known in the art. Typically, a basestation operator has two options for using more than one radio. The operator may transmit using these radios through independent antennas. Disadvantageously, this requires multiple antenna structures on the basestation tower or structure. Alternatively, the operator might choose to combine the outputs, but the problem with such combining is that a loss of three dB typically results. Another method, alternate carrier combining, uses carrier frequencies spaced far enough apart to enable lower loss combining but loss still results. Eventually, an operator will exhaust available spectrum flexibility for alternate carrier combining and the operator will be forced to combine output or use independent antenna structures.

Thus, to use more than one radio, a basestation operator is typically forced to either add more antennas or accept a combining loss. As a result, extra expense in physical antennas and the cost of deploying them, or a degradation of the signal quality because of these combining losses results. Furthermore, adding more antennas may raise several problems for a basestation operator such as zoning and space problems associated with installing the additional antennas on an existing tower or lease site. To overcome the three dB of loss due to signal combining an operator will typically add three dB of gain, typically through extra amplifiers, using extra power, also resulting in extra cost.

### BRIEF SUMMARY OF THE INVENTION

The present invention is directed to systems and methods which provide independent transmit paths within a single phased-array antenna using hybrid micro-strip structures or the like. The present system and methods effectively combine two independent RF signals with low loss and transmit the combined signals from a common phased-array antenna with nearly identical radiation patterns. These systems and methods may employ micro-strip or strip-line hybrid structures and properties of phased-array antenna systems used for beam-forming applications, such as antenna arrays disclosed in the above incorporated U.S. Published Patent Application number 2002/0193104, and manufactured by Metawave Communications Corporation. One application of the present invention allows GSM and CDMA operators, or the like, to combine signals from two separate signal sources and transmit them from a single antenna without the three dB loss incurred with standard signal combining methods. An embodiment of the present effective low-loss combining systems and methods employs hybrid array element-sharing to exploit redundancy typically exhibited by phased-array antennas used in beam-forming applications. For example, one embodiment of the present systems and methods enable production of two independent, nearly identical 65-degree co-spatial patterns from a single antenna array.

In accordance with one embodiment of the present invention an antenna array is used in conjunction with a feed system, which in turn uses a series of hybrid matrices to allow each radio access to elements in the array, and to, in effect, share an aperture. Technical challenges associated with the present invention include designing hybrid matrices such as to provide the desired response through the feed system, to thereby synthesize a desired radiation pattern.

Advantageously, embodiments of the present invention facilitate sharing a single antenna aperture to alleviate a need to add more antennas to a basestation tower. The loss imposed by the present structure is on the order of one dB, similar to that imposed by an antenna array feed system in any case, as opposed to the three dB loss associated with existing combining systems.

As a further advantage, the present systems and methods enable independent control over the signals that are being combined. Therefore, identical patterns for the plurality of signals may be synthesized in accordance with the present invention or different patterns may be synthesized, if desired, in accordance with the present invention. Situations where different patterns might be desirable may include where one basestation radio is primarily responsible for data communications, and another basestation radio is responsible for voice communications. Slightly different coverage for the data communication may be appropriate because users are in buildings or are less mobile, such that the optimal radiation pattern would be something other than what is optimal for voice coverage. For example, an antenna pattern overlaying the buildings may be more desirable for data transmissions while coverage of nearby roadways may be more important to operation of the voice radio.

An object of embodiments of the present invention is to allow multiple inputs to a feed system to share elements in the array. Embodiments of the present invention preferably uses a series of hybrid matrices. Hybrid matrices according to preferred embodiments comprise micro-strip or strip-line structures known in the art. Hybrid matrices, according to preferred embodiments, are adapted to allow multiple signals to be combined at low loss if combined in a very structured manner. Using hybrid matrices in this manner takes advantage of heretofore unused or under-used redundancy in an antenna array. As a result, the array may, in effect, be used by each input to span the space of possible synthesized antenna patterns. In other words, there is more than one set of corresponding array weighting coefficients that will produce a given desired radiation pattern with an antenna array; there are different feed systems that can provide desired radiation patterns. The present invention advantageously exploits redundancy in an antenna array to overcome constraints in hybrid matrix structures to provide such desired patterns for multiple inputs.

In accordance with embodiments of the present invention, a target radiation pattern to be shared by multiple inputs is achieved using an antenna array by using optimization. This optimization may take the form of a numerical searching algorithm that searches for combinations of hybrid matrices for a given topology that best achieves the desired pattern. This optimization can be extended to search not only for optimal parameters of a single topology but across multiple topologies as well. As used herein, a topology is an arrangement of hybrid matrix structures in a feed circuit, such as may be provided by hybrid structures on a circuit card that may dictate where hybrid matrices exist on the feed system. Many different topologies may be provided by such a card to achieve different results. The manner in which the hybrid matrices are arranged and the manner in which they are interconnected define a topology. A simplest topology might have just a single hybrid matrix, but topologies that incorporate multiple hybrid matrices are also anticipated by the present invention and discussed in greater detail below.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 is a graphical illustration of an example of prior art antenna patterns obtainable using a phased antenna array;

FIG. 2 is a diagrammatic illustration of an embodiment of an antenna array feed network in accordance with the present invention employing a first topology using a single hybrid matrix;

FIG. 3 is a graphical illustration of a model antenna pattern and a pair of generally co-spatial antenna patterns obtained using a single phased antenna array in accordance with the present invention;

FIG. 4 is a diagrammatic illustration of another embodiment of an antenna array feed network in accordance with the present invention employing another topology using multiple hybrid matrices;

FIG. 5 is a diagrammatic illustration of a micro-strip or strip-line structure of an embodiment of a hybrid matrix such as employed in the feed networks of FIG. 2 or FIG. 4; and

FIG. 6 is a diagrammatic illustration of a micro-strip or strip-line feed network embodying the feed network of FIG. 2, including the hybrid matrix.

### DETAILED DESCRIPTION OF THE INVENTION

Ideally, each radio input or output of a basestation radio would have access to all of the columns of a basestation antenna array in an independent fashion. However, this is typically not physically realizable. Embodiments of the present invention employ hybrid matrix structures to allow two or more signals to be combined to share a radiation pattern or parts thereof. In accordance with embodiments of the present invention effective low-loss signal combining systems and methods may employ hybrid combiner based array element-sharing for beam-forming, thereby exploiting redundancy typically exhibited by phased-array antennas. These systems and methods enable the production of multiple independent, nearly identical radiation patterns from a single antenna array.

If the amplitude and phase response of a phased-array antenna are known, various radiation patterns may be produced by the array according to the amplitudes and phases of the signals driving the antenna elements in accordance with the present invention. The beamforming amplitudes and phases may be adjusted, for example, by designing micro-strip beamformer power dividers or, “personality modules” such as described in copending, commonly owned Published U.S. Patent Application number 2002/0193104 entitled SHAPABLE ANTENNA BEAMS FOR CELLULAR NETWORKS, incorporated herein by reference above, in accordance with the present invention. For example, an 8-element phased-array antenna generally requires specifying 8 signal amplitudes and 7 relative phase values, corresponding to the 8 elements of the antenna driven by the beamformer network. A personality module is a feed system to an antenna array, or a portion of the feed system of an antenna array. An array may be composed of a variety of antenna elements, such as both horizontal elements and vertical elements, disposed in a known geometry, such as columns and/or rows. According to one embodiment, a personality card distributes the signal to each of the columns, and each of the columns then has its own feed system that distributes the signals to each of the rows in the array. The personality card is field replaceable so that it can be removed and changed to effect different radiation patterns. By changing the personality card characteristics of the feed to each of the columns in the antenna array, the resulting radiation pattern may be changed.

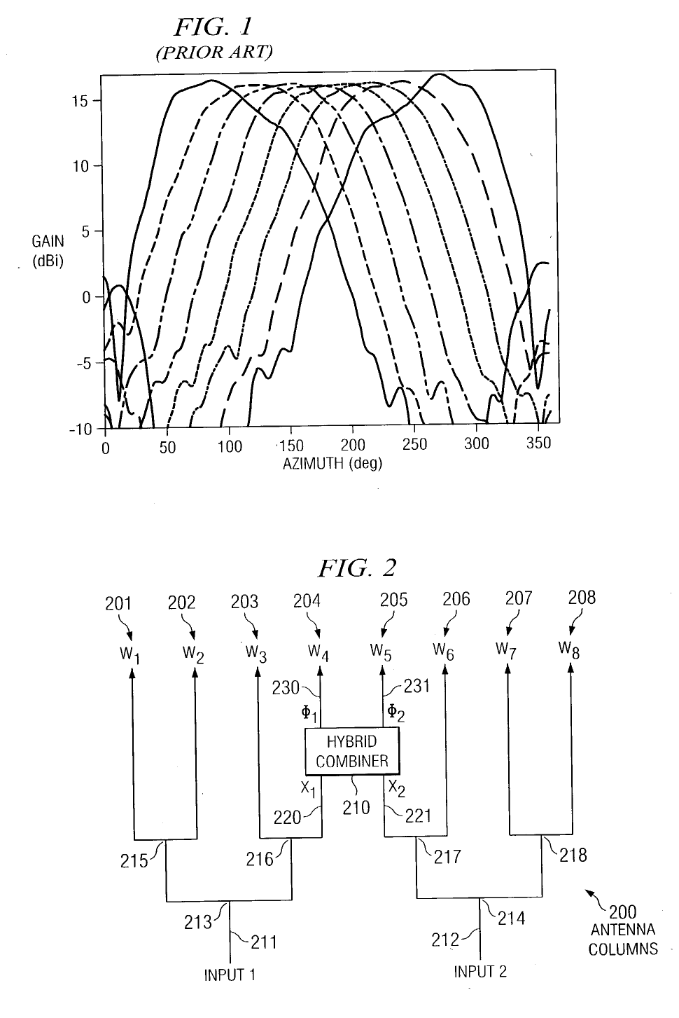

An example of a measured antenna manifold (response) for a prior art antenna array is shown in FIG. 1. FIG. 1 is a plot of the magnitude of the response as a function of azimuth or angle around an antenna array. FIG. 1 illustrates that for a particular array antenna, there is an inherent redundancy manifest by the response of individual columns of an antenna array. These responses tend to overlap in their azimuth. In other words, FIG. 1 shows there is significant overlap between neighboring columns in an antenna array. The result of this overlap is that different sets of beamformer coefficients can be found that produce very similar composite radiation patterns. This is particularly true for many commonly used patterns, such as a 65-degree azimuthal beamwidth pattern aligned with an antenna element.

In operation, embodiments of the present invention weights these individual responses of an array to synthesize a pattern. In accordance with the present invention, a linear combination of individual column responses produces a desired far field radiation pattern when array elements are fed using a set of weights. This enables reuse or sharing of some of the columns of an array between two or more signals that are combined in accordance with embodiments of the present invention. Thus, the present invention enables production of independent radiation patterns from a single antenna array.

The present invention affects a particular radiation pattern out of a given antenna array by initiating a set of complex weights that describe the amplitudes and phases of the signals driving the individual elements of the antenna array. One aspect of embodiments of the present invention includes choice of the properties of the hybrid combiners or the parameters that describe them. These properties or parameters may include the ratio of the power split and the phases of the signals emanating from the hybrid combiners. Choices of these properties or parameters are made in such a way as to produce the desired corresponding weights used to obtain the desired patterns for the various inputs. The desired pattern may be obtained by varying the power split and phase parameters using an optimization algorithm, to define a metric related to the desired pattern. Obtaining the desired pattern may also call for searching for parameter values that will produce the desired weights. Many different optimization algorithms may be used in accordance with the present invention to obtain the power splits and phase parameters for a desired beam pattern.

Given the redundancy of the inherent response of an antenna array it is possible to generate independent sets of coefficients that would simultaneously produce two independent radiation patterns with approximately the same pattern, provided that at least some of the columns can be shared using a hybrid micro-strip combiner structure. The hybrid combiner imposes certain constraints, or fixed relationships, between the coefficients for the columns addressed or shared by the hybrid. The redundancy in the antenna array response has been found to be sufficient to overcome constraints imposed by a hybrid combiner in developing the present invention.

The logical structure of a particular feed network 200 is shown in FIG. 2. In this example, columns 204 and 205 are shared so that one pattern can be produced with columns 201 through 205, and a second, independent pattern can be produced using columns 204 through 208.

FIG. 2 is a diagrammatic illustration of an embodiment of an antenna array feed network 200 in accordance with the present invention employing a first topology using a single hybrid matrix combiner 210. In the example of FIG. 2, the columns 201 through 208 of the antenna array are assumed to be arranged in a semicircle so each element 201 through 208 in the array populates a sector on a circle. So, when synthesizing a pattern that is normal or broadside to that half circle or half cylinder of the illustrated array, columns 204 and 205 are most influential in synthesizing that pattern. Hence, hybrid combiner 210 is shown sharing columns 204 and 205 between inputs 211 and 212. Each of inputs 211 and 212 gets divided once at 213 and 214, respectively, and then divided again, at 215 and 216 for input 211 and at 217 and 218 for input 212, so that each input is broken into four feeds, two of which, 220 and 221 are then sent through hybrid combiner 210, which splits each signal between columns 204 and 205, thereby combining signal X₁ on feed 220 with signal X₂ on feed 221 in such a manner that their phase relationship and amplitude relationship are described by the equation discussed below and output via respective links 230 and 231 with phase angles Φ₁ and Φ₂ to columns 204 and 205, respectively.

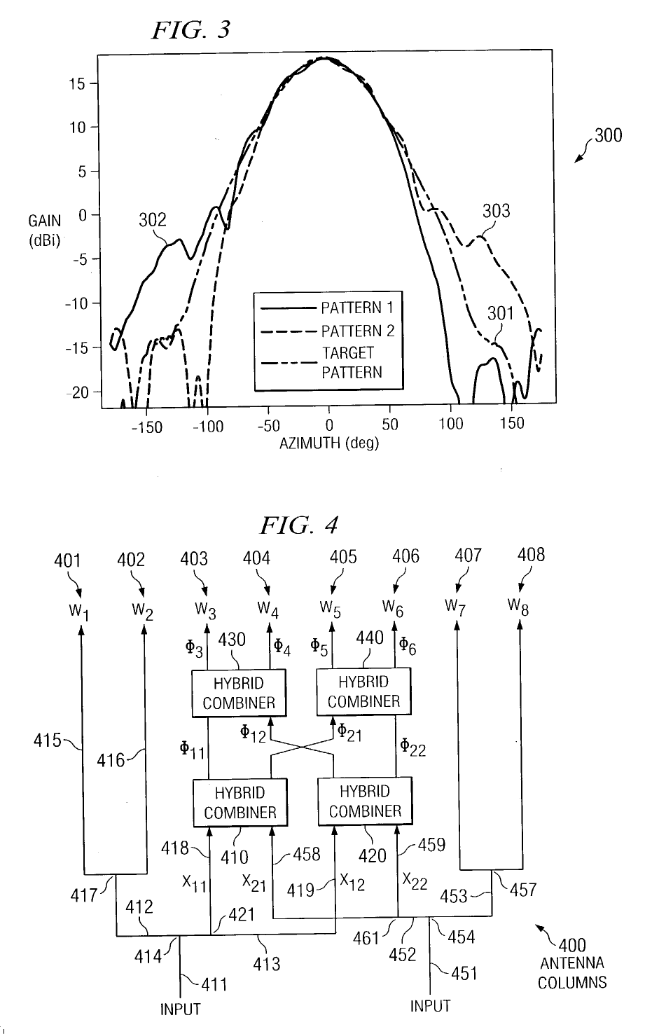

FIG. 3 shows best-fit 65-degree patterns provided if columns 204 and 205 of the antenna array of FIG. 2 are shared as shown. FIG. 3 shows a desired radiation pattern 301, which, in this case is normal to the face of the antenna with a beam width of approximately 65 degrees. Superimposed on pattern 301 are two curves showing independent patterns 302 and 302 that are produced using the logical structure described in FIG. 2 and the antenna array that produces the antenna patterns of FIG. 1.

Given a desired pattern and that the pattern obtained for any set of hybrid parameters can be computed, a search over that space may be used to find a pattern that most closely matches the desired pattern. Embodiments of the present invention include manners of determining the parameters of the hybrid combiner that define the hybrid combiner's specific operation with respect to a particular antenna array and the desired radiation pattern. The outputs of a hybrid combiner (complex weights, W₂₀₄ & W₂₀₅) are given by:

W₂₀₄=(ax₁+bx₂e^{iπ/2})e_{iφ}^{₁}

W₂₀₅=(ax₂+bx₁e^{iπ/2})e^{iφ}^{₂}

a²+b²=1

where the hybrid ratio, R=a/b, and the phases, Φ₁, Φ₂ are adjustable parameters of the hybrid, and x₁, x₂ are the respective inputs 211 and 212 as shown in FIG. 2. The patterns shown in FIG. 3 were derived by minimizing a weighted sum-squared difference objective between the predicted patterns and the target pattern with respect to parameters representing the amplitudes and phases corresponding to W₂₀₁-W₂₀₃ & W₂₀₆-W₂₀₈, x₁, x₂, and the hybrid parameters, R, Φ₁, Φ₂ (a total of 17 parameters) using a modified version of Powell's direction-set method.

According to embodiments of the present invention, the hybrid combiner structure combines two independent RF input signals and provides two corresponding outputs described by the set of equations above. The first equation specifies that one output is a particular linear combination of the inputs with amplitude ratio, R=a/b, the phase of the second input advanced by π/2 (90 degrees) with respect to the phase of the first input, and the output phase additionally advanced by Φ₁. The second equation relates the second output in a similar manner: the ratio of the inputs combined is the inverse of that for the first equation (b/a), the phase of the first input is advanced with respect to the second by π/2 (90 degrees), and the phase of the second output is additionally advanced by Φ₂. The specific values of R, Φ₁, and Φ₂ are design parameters of the hybrid structure (i.e., hybrid structures can be designed to behave according to the set of equations with any desired set of those values). The last equation in the set describes that a (lossless) hybrid combiner behaves so that the total power summed at the two outputs is equal to the total power summed at the two inputs.

FIG. 2 relates to this set of equations in that FIG. 2 illustrates an application for this set of equations. So, for example, the weights, or phase and amplitude responses of the signals driving columns 204 and 205 in the array are related by the set of equations above. It should be appreciated that a defined relationship between the signals driving columns 204 and 205 is a constraint according to the illustrated embodiment because the weights associated with columns 204 and 205 in the array cannot be arbitrarily and independently set due to their mutual interdependency in forming a plurality of radiation patterns. So in other words, for input signals x, and x₂ in the equation, with a hybrid matrix whose characteristics are defined by parameters a and b, and where Φ₁ and Φ₂ are phase angles associated with that structure, the above equations indicate how the complex coefficients, the amplitudes and phases for two columns of the array will actually appear at the output of that hybrid matrix. This indicates how those columns of the antenna array will be excited in a particular combining scheme.

Turning to FIG. 4, another topology (400) is shown. To provide more flexible antenna pattern radiation characteristics, more antenna columns are to be shared by the feed network using hybrid combiner structures 410, 420, 430 and 440 according to a preferred embodiment. To that end, FIG. 4 shows a more complicated, but more flexible, signal combining scheme.

A hybrid combiner typically has three degrees of freedom. A hybrid combiner embodies a ratio which defines how power of a signal is divided or split. A hybrid combiner has two phase parameters that basically describe how the phase relationship between the two outputs of the hybrid combiner, relative to one another. So, more hybrid combiners in a feed network, means more degrees of freedom in the feed network. In FIG. 4 the degrees of freedom with respect to the feed network are quadrupled with respect to FIG. 2. While the topology of FIG. 2 typically results in relatively low loss. More complex topology 400, shown in FIG. 4, provides more flexibility.

In FIG. 4 input 411 is divided into two paths 412 and 413 at 414. Left path 412 is further divided into two paths, 415 and 416 at 417. Paths 415 and 416 feed columns 401 and 402, respectively. Initial right path 413 is split into paths 418 and 419 at 421 to be fed into hybrid combiners 410 and 420 as signals, X₁₁ and X₂₁, respectively. Hybrid combiner 410, acts as a splitter dividing input signal X₁₁. That division is described by a ratio which may not be symmetrical, In other words, half the energy does not necessarily go left, and half the energy right out of any of the hybrid combiners. The split in the hybrid combiners can be arbitrary; this is one of the degrees of freedom of the hybrid combiners. However, a constraint on feed network 400 of FIG. 4 is imposed in that a portion of input 451 goes through the same hybrid combiner (hybrid combiner 410) as a portion of input 411 to facilitate sharing of particular antenna elements. So if input 411 is split by half in hybrid combiner 410, then input 451 is split by half as well. If input 411 has ¼ of the energy going to a left arm of hybrid combiner 410 and 3/4 of the energy going to a right arms input 451 has 3/4 going to the left arm and ¼ going to the right arm, in a reflective manner.

Returning to input 411, two paths 418 and 421 feed hybrid combiners 410 and 420, respectively. Similarly, input signal 451 is split into feeds 452 and 453 at 454. Feed 453 is split at 457 to feed antenna columns 407 and 408. Feed 452 is split at 461 to feed signal X₁₂ to hybrid combiner 410, via feed 458 and to feed signal X₂₂ to hybrid combiner 420, via feed 459. Power dividers such as may be employed at 414, 417, 421, 454, 457 and 461 may be micro-strip or strip-line structures, or alternatively additional hybrid combiners, possibly with single inputs.

The signals are split in hybrid combiners 410 and 420 and then fed to hybrid combiners 430 and 440 with phases Φ₁₁, Φ₁₂, Φ₂₁, and Φ₂₂. Hybrid combiners 430 and 440 each again splits the signals and shifts the phase of the resulting signals to Φ₃, Φ₄, Φ₅, and Φ₆ for feeding to antenna columns 403, 404, 405 and 406. Based on how the phase parameters associated with each hybrid combiner is set and the ratio of how the signal is split in each hybrid combiner, which may be provided in a relatively arbitrary fashion according to a design of the hybrid combiner, a desired response and/or a desired phase and amplitude relationship between columns 3, 4, 5 and 6 results which synthesizes antenna patterns of interest.

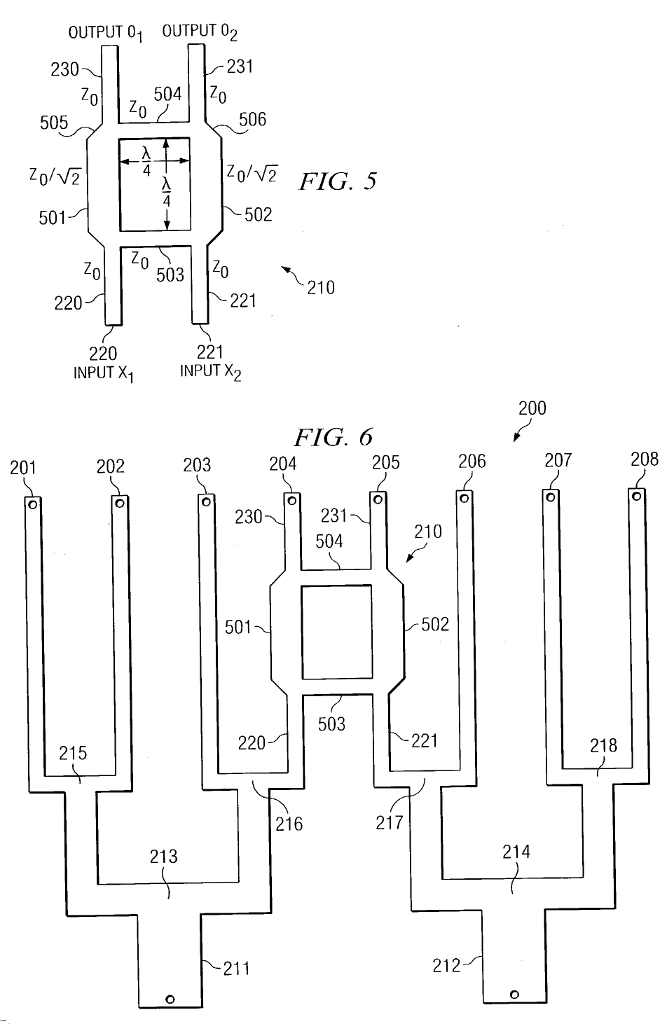

FIG. 5 is a diagrammatic illustration of a micro-strip or strip-line structure of an embodiment of a hybrid matrix such as employed in the feed networks of FIG. 2 or FIG. 4. FIG. 5 is numbered in accordance with hybrid combiner 210 of FIG. 2; wherein input signals X₁ and X₂ are provided to hybrid combiner 210 on feeds 220 and 221, respectively and outputs with phases Φ₁, and Φ₂ are provided on feeds 230 and 231. Input feed lines 220 and 221 and output feed lines 230 and 231 are shown as having a width providing an impedance Z₀. Within hybrid combiner 210, combiner lines 501 and 502 are shown having widths sufficient to provide impedance of Z₀ divided by the square root of two so that the impedance is matched across junctions 505 and 506. Similarly, crosslink lines 503 and 504 have a width appropriate to provide an impedance of Z₀ similar to feed lines 220, 221, 230 and 231. Combiner lines 501 and 502 are preferably spaced apart by one-fourth of the wavelength of input signals X₁ and/or X₂ to match the impedance and thereby minimize reflections at the junctions 505 and 506. Similarly, crosslink lines 503 and 504 are also preferably spaced apart by one-fourth of the wavelength of input signals X₁ and X₂. Thus input signals X₁ and X₂ are combined by combiner 210 and provided relative phases of Φ₁, and Φ₂. In strip-line and micro-strip versions of hybrid combiner 500, for example, the relative phases may be provided by adjusting the relative lengths of traces 501, 502, 503 and 504.

FIG. 6 is a diagrammatic illustration of a micro-strip or strip-line feed network embodying feed network 200 of FIG. 2, including hybrid matrix 210. FIG. 6 is numbered consistently with FIGS. 2 and 5 above. Inputs 211 and 212 are split a 213 and 214, respectively. One resulting path of input 211 is split at 215 to feed antenna columns 201 and 202. The other path from input 211 is split to feed antenna column 203 and to feed into hybrid matrix 210 via line 220. Similarly, one resulting path of input 212 is split at 218 to feed antenna columns 207 and 208. The other path from input 212 is split to feed antenna column 206 and to feed into hybrid matrix 210 via line 221. In hybrid matrix 210 the input signals provided via lines 220 and 221 are combined and provided relative phases of Φ₁, and Φ₂ and output on lines 230 and 231 to antenna columns 204 and 205.

Alternatively, the present invention may be practiced using waveguides, digital manipulation of an analog feed signal or direct manipulation of a digital feed signal rather than hybrid combiners. Also strip-line or micro-strip directional couplers might be used to practice the present invention in a fashion similar to how hybrid matrix combiners are used in the description above. A directional coupler might be more appropriate when the requisite power division between output signals is in excess of 10 dB (i.e. the output power of one branch exceed the output power of the other branch by 10 dB). As a further alternative a mix of directional couplers and hybrid matrix combiners might be used to practice the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for providing independent antenna patterns for a plurality of inputs using a single phased-array antenna comprising:
splitting each of a plurality of inputs into a plurality of signal paths;
combining at least one signal split from each of said inputs, said combining comprising:
advancing a phase of a signal of a first of said paths by a first amount;
advancing a phase of a signal of another of said paths by a second amount; and
correspondingly weighting said first signal and said another signal; and
outputting said combined signals to a shared plurality of said antennas of said array.

2. The method of claim 1 wherein said advancing a phase of a signal of another of said paths by a second amount comprises advancing said another signal by an amount greater than π/2 relative to an initial phase of said first signal.

3. The method of claim 1 wherein said independent antenna patterns are co-spatial.

4. The method of claim 1 further comprising:
feeding at least one of said plurality of paths for each of said inputs to at least one specific antenna of said array.

5. The method of claim 1 further comprising:
distributing ones of said signal paths of each of said signals directly to separate sets of antenna columns of said antenna array.

6. The method of claim 5 wherein said outputting comprises:
feeding each of said combined signals to a column of said antenna array associated with each of said sets to synthesize cospatial radiation patterns for each of said inputs.

7. The method of claim 6 wherein said columns of said sets receiving said signals directly are adjacent columns.

8. The method of claim 7 wherein said columns receiving said combined signals are directly adjacent said columns of said associated set.

9. The method of claim 8 wherein said columns receiving said combined signals are directly adjacent.

10. The method of claim 1 wherein said combining is carried out using hybrid combiners.

11. The system of claim 10 wherein said hybrid combiners comprise micro-strip hybrid combiners.

12. The system of claim 10 wherein said hybrid combiners comprise strip-line hybrid combiners.

13. The method of claim 10 further comprising:
choosing parameters of said hybrid combiners.

14. The method of claim 13 wherein said parameters include a ratio of a power split of said paths in said combiner.

15. The method of claim 13 wherein said parameters include phases of signals output by said combiner.

16. The method of claim 13 wherein said choosing comprises choice of parameters to produce desired weights used to obtain desired output antenna patterns for said inputs.

17. The method of claim 16 wherein said desired output antenna patterns are obtained by varying power split and phase parameters of said hybrid combiners using an optimization algorithm to maximize a metric related to said desired pattern.

18. The method of claim 16 wherein said desired output antenna patterns are obtained by varying power split and phase parameters of said hybrid combiners using an optimization algorithm to minimize a metric related to said desired pattern.

19. The method of claim 10 further comprising:
obtaining a desired pattern by searching for hybrid parameter values that will produce said desired weights.

20. The method of claim 19 wherein said parameters include a ratio of a power split of said paths in said combiner.

21. The method of claim 19 wherein said parameters include phases of signals output by said combiner.

22. The method of claim 4 further comprising sharing elements of said antenna array using said combiner.

23. The method of claim 1 wherein said paths are waveguides.

24. The method of claim 1 wherein said combining is carried out using digital manipulation of an analog input feed signal.

25. The method of claim 1 wherein said combining is carried out using direct manipulation of a digital input feed signal.

26. The method of claim 1 wherein said combining is carried out using directional couplers.

27. The method of claim 26 wherein power division between said output signals is in excess of 10 dB.

28. The method of claim 26 wherein said directional couplers are strip-line directional couplers.

29. The method of claim 26 wherein said directional couplers are micro-strip directional couplers.

30. The method of claim 1 wherein said combining is carried out using directional couplers and hybrid matrix combiners.

31. A system for providing independent transmit paths within a phased-array antenna comprising:
a feed network for feeding antennas of said array, said feed network receiving a plurality of inputs;
means for feeding each of said inputs to specific sets of said antennas;
means for advancing a phase of a signal of a feed of a first of said inputs by a first amount;
means for advancing a feed of another of said inputs by another amount;
means for combining said signals to be output with corresponding weighting; and
means for outputting said correspondingly weighted signals to a shared plurality of said antennas of said array.

32. The system of claim 31 wherein said another amount is greater than π/2 relative to an initial phase of said first signal.

33. The system of claim 31 wherein said means outputting comprises:
means for feeding each of said combined signals to a column of said antenna array associated with each of said sets to synthesize cospatial radiation patterns for each of said inputs.

34. The system of claim 33 wherein said columns of said sets receiving said signals directly are adjacent columns.

35. The system of claim 34 wherein said columns receiving said combined signals are directly adjacent said columns of said associated set.

36. The system of claim 35 wherein said columns receiving said combined signals are directly adjacent.

37. The system of claim 31 wherein said independent paths provide co-spatial antenna patterns for said plurality of inputs.

38. The system of claim 31 wherein said advancing and combining means comprise at least one hybrid combiner.

39. The system of claim 38 wherein said at least one hybrid combiner comprises at least one micro-strip hybrid combiner.

40. The system of claim 38 wherein said at least one hybrid combiner comprises at least one strip-line hybrid combiner.

41. The system of claim 38 wherein parameters of said at least one hybrid combiner produces desired phase advancements and power splits for said signals to obtain desired output antenna patterns for said inputs.

42. The system of claim 41 wherein desired output antenna patterns are obtained by varying power split and phase advancement parameters of said at least one combiner using an optimization algorithm to minimize a metric related to said desired pattern.

43. The system of claim 41 wherein desired output antenna patterns are obtained by varying power split and phase advancement parameters of said at least one combiner using an optimization algorithm to maximize a metric related to said desired pattern.

44. The system of claim 41 wherein a desired antenna pattern is obtained by searching for hybrid parameter values that will produce desired antenna patterns.

45. The system of claim 31 wherein said feed network comprises strip-line structures.

46. The system of claim 31 wherein said feed network comprises micro-strip structures.

47. The system of claim 31 wherein said feed network comprises waveguides

48. The system of claim 31 wherein said advancing and combining means comprises means for digitally manipulating an analog input feed signal.

49. The system of claim 31 wherein said advancing and combining means comprises means for directly manipulating digital input feed signals.

50. The system of claim 31 wherein said advancing and combining means comprises directional couplers.

51. The system of claim 50 wherein power division between said output signals is in excess of 10 dB.

52. The system of claim 50 wherein said directional couplers are strip-line directional couplers.

53. The system of claim 50 wherein said directional couplers are micro-strip directional couplers.

54. The system of claim 31 wherein said advancing and combining means comprises directional couplers and hybrid matrix combiners.

55. A method for selecting a feed network topology for providing a plurality of antenna beam patterns for corresponding inputs using a single phased-array antenna, said method comprising:
choosing corresponding power split parameters and phase parameters of at least one hybrid matrix combiner disposed in a signal feed network feeding a combined plurality of input signals to ones of antenna elements of a phased antenna array;
wherein said parameters are correspondingly selected to advance a phase a first signal by a first amount, advance a phase of a second signal by a second amount greater than π/2 and correspondingly power split said first and second signals to be output by said combiner to obtain desired antenna patterns for said inputs.

56. The method of claim 55 wherein said parameters for desired antenna patterns are chosen by using an optimization algorithm to define a metric related to said desired pattern.

57. The method of claim 55 wherein said parameters for desired antenna patterns are chosen by using an optimization algorithm to minimize a metric related to said desired pattern.

58. The method of claim 55 wherein said parameters for desired antenna patterns are chosen by using an optimization algorithm to maximize a metric related to said desired pattern.

59. The method of claim 55 wherein said choosing further comprises obtaining a desired pattern by searching for hybrid parameter values that will produce said desired pattern.
